(19) United States
(12) Patent Application Publication
(10) Pub. No.: US 2010/0213399 A1
(43) Pub. Date: Aug. 26, 2010

(54) Assembly structure of lever handle and valve plug

(76) Inventor: Liguo Yan, Shen Zen (CN)

Correspondence Address: Dr. BANGER SHIA;Patent Office of Bang Shia, 102 Lindencrest Ct, Sugar Land, TX, 77479-5201, US

(21) Appl. No.: 12/390,529

(22) Filed: Feb. 23, 2009

(51) Int. Cl. F16K 31/44

(52) U.S. Cl. 251/235

(57) ABSTRACT

An assembly structure of a lever handle and a valve plug, wherein at least two positioning grooves are formed in the inner surface of a mounting hole of the lever handle which is made of metal, a non-metal clamping member has two pushing wedges inserted in the positioning grooves, and a second connecting portion of the valve plug is inserted in the mounting hole of the lever handle and is axially fixed by a locking member. Plural arc-shaped concave surfaces formed on the pushing edges are abutted against the teeth of the second connecting portion of the valve plug in an interference fit, so as to prevent the looseness between the lever handle and the valve plug and the accelerated wear and tear caused by the fit clearance between the teeth.

### BACKGROUND OF THE INVENTION

1. Field of the Invention

The present invention relates to a faucet, and more particularly to an assembly structure of a lever handle and a valve plug.

2. Description of the Prior Art

The lever handle and the valve plug of a conventional faucet are mostly assembled in such a manner that the lower end of the lever handle is defined with a toothed hole which is to be engaged with a toothed rod on the top of the valve plug, and then a bolt is screwed through the toothed hole of the lever handle and onto the top of the toothed rod. To ensure the torque transmission and engagement strength between the teeth of the lever handle and that of the valve plug, the lever handle and the valve plug are normally made of metal material. In addition, for facilitating assembly, there normally is a clearance a between the teeth 1 of the lever handle and the teeth 2 of the valve plug, as shown in FIG. 1. In rotation of the lever handle, the valve plug is likely to become loose or unsteady because of the clearance, which further accelerates wear and tear on the teeth, and results in the wear and tear area 1a and 2a as shown in FIG. 2. Hence, the looseness between the lever handle and the valve plug is increased and as a result, the lever handle is unable to rotate and position precisely, affecting the quality of the lever handle and shortening the life of the product.

The present invention has arisen to mitigate and/or obviate the afore-described disadvantages.

### SUMMARY OF THE INVENTION

The primary object of the present invention is to provide an assembly structure of a lever handle and a valve plug, wherein the assembly is easy to assemble and the lever handle and the valve plug can be closely assembled to prevent the looseness therebetween, thus improving the quality while extending the life of the product.

To achieve the above object, an assembly structure of a lever handle and a valve plug comprises:

a lever handle including a metal made first connecting portion, a bottom of the first connecting portion being defined with a mounting hole, and around an inner periphery of the mounting hole being defined at least two spaced-apart axially extending positioning grooves, and between the positioning grooves being formed plural teeth;

a valve plug having a metal made second connecting portion to be inserted in the mounting hole of the lever handle in such a manner that plural teeth formed around one end of the second connecting portion are engaged with the teeth of the mounting hole;

a locking member inserted through the mounting hole and fixed to an end of the valve plug; and

a clamping member made of non-metal material and having at least two pushing wedges and a connecting portion formed at an end of the pushing wedges facing a bottom of the mounting hole, the pushing wedges being positioned in the corresponding positioning grooves of the mounting hole and each having an arc-shaped concave surface for pressing against the teeth of the valve plug, and the connecting portion being clamped between the bottom of the mounting hole of the lever handle and the end of the valve plug.

The connecting portion of the clamping member is ring-shaped or C-shaped.

An end of the respective pushing wedges facing a top end of the mounting hole is formed with an inclined surface through which the teeth are guided to and abutted against the corresponding arc-shaped concave surfaces.

The clamping member is integrally formed by plastic material.

The non-metal clamping member can be used to eliminate the fit clearance between the lever handle and the valve plug while maintaining the conventional teeth engagement, ensuring the tensional resistance during teeth transmission. Hence, the lever handle won't be loose and unstable when in use, and the accelerated wear and tear caused by the fit clearance between the teeth can also be prevented. Besides extending the life of the product, the present invention further permits the lever handle to be rotated and positioned more precisely.

### BRIEF DESCRIPTION OF THE DRAWINGS

FIG. 1 is a partial illustrative view showing that the lever handle and the valve plug of a conventional faucet are engaged in a clearance fit;

FIG. 2 shows the wear areas between the lever handle and the valve plug of the conventional faucet;

FIG. 3 is an assembly view of an assembly structure of a lever handle and a valve plug in accordance with a first embodiment of the present invention;

FIG. 4 is an exploded view of the assembly structure of the lever handle and the valve plug in accordance with the first embodiment of the percent invention;

FIG. 5 is an exploded view showing the body of the lever handle and the clamping member in accordance with the first embodiment of the present invention;

FIG. 6 is an assembly view of the body of the lever handle and the clamping member in accordance with the first embodiment of the present invention;

FIG. 7 is an axial cross sectional view of the assembly structure of the lever handle and the valve plug in accordance with the first embodiment of the present invention;

FIG. 8 is a radial cross sectional view of the assembly structure of the lever handle and the valve plug in accordance with the first embodiment of the present invention; and

FIG. 9 shows a clamping member in accordance with a second embodiment of the present invention.

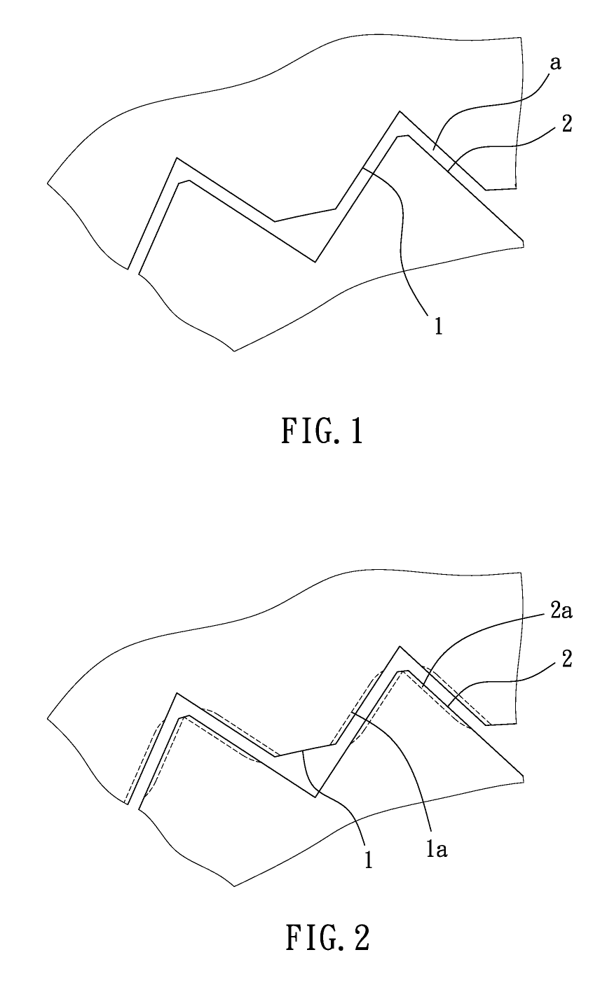

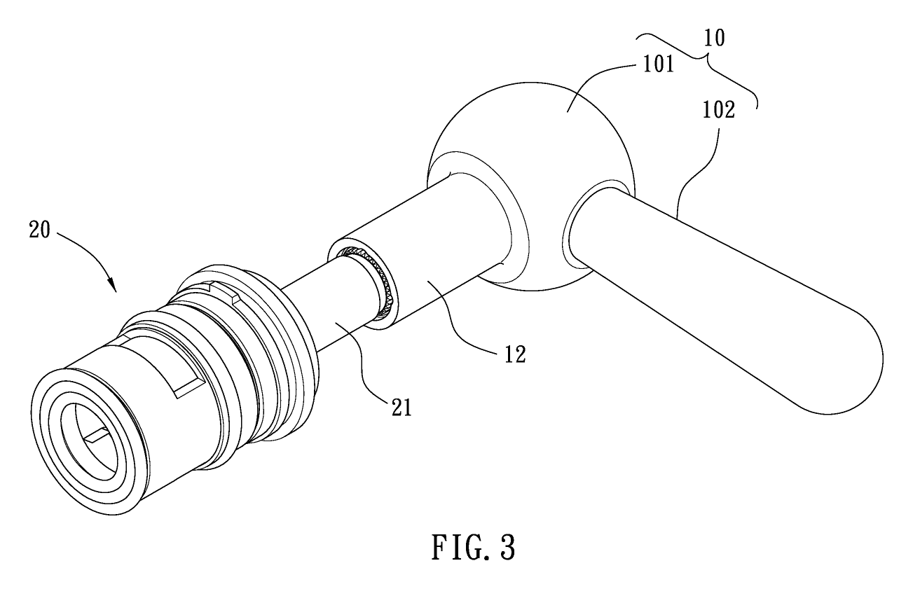

### DETAILED DESCRIPTION OF THE PREFERRED EMBODIMENTS

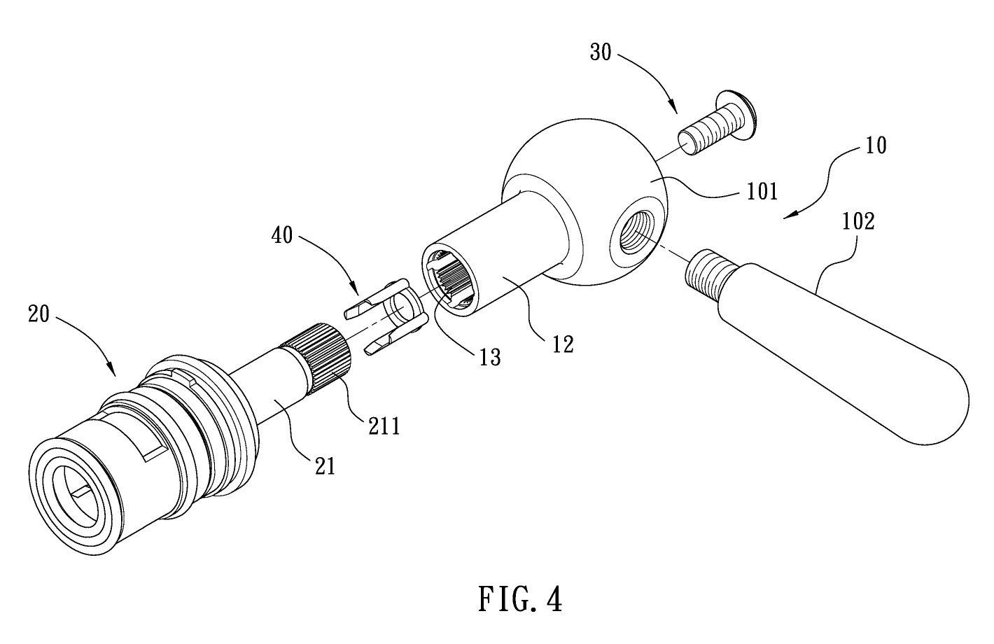

Referring to FIGS. 3 and 4, an assembly structure of a lever handle and a valve plug in accordance with a first embodiment of the present invention comprises: a lever handle 10, a valve plug 20, a locking member 30 and a clamping member 40.

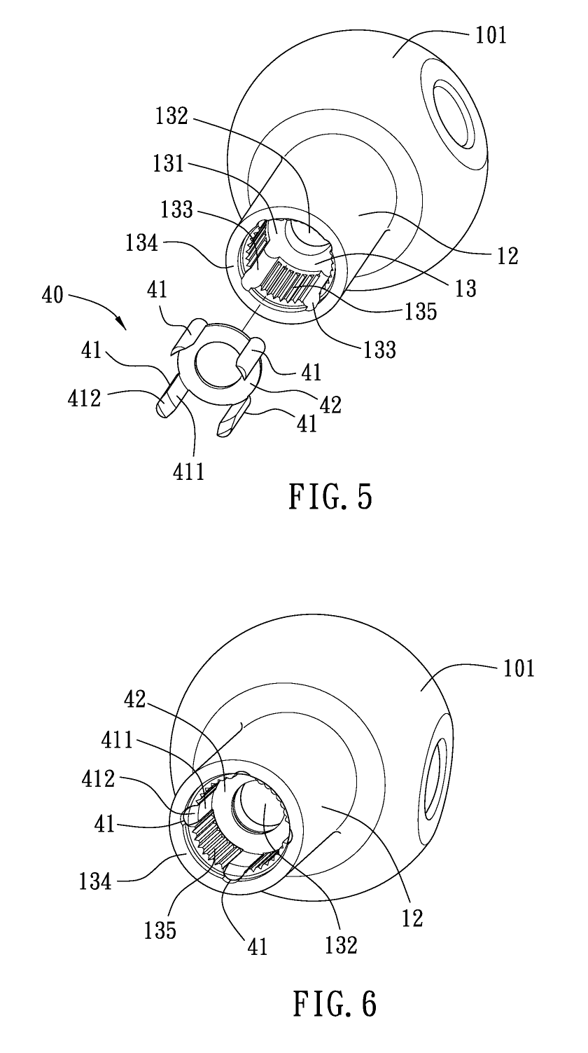

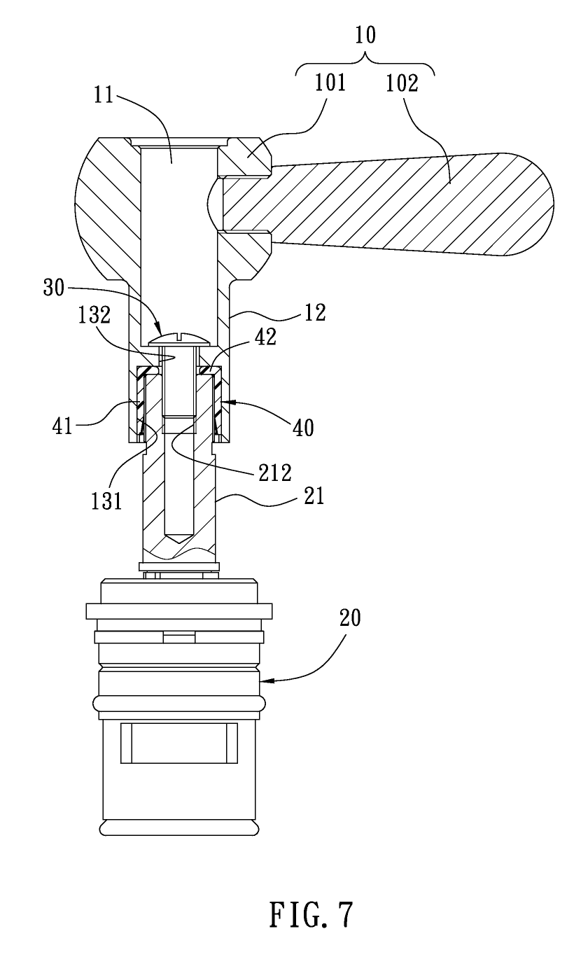

The lever handle 10, as further shown in FIGS. 5 and 7, includes a metal-made body 101 and a metal lever handle portion 102 to be fixed to the body 101. In the top of the body 101 is defined a cavity 11, and extended from the bottom of the body 101 is a rod-shaped first connecting portion 12. The bottom of the first connecting portion 12 is defined with a mounting hole 13, and in the center of a bottom 131 of the mounting hole 13 is an aperture 132 which is in communication with the cavity 11. Further, around the inner periphery of the mounting hole 13 are equiangularly defined four spaced-apart positioning grooves 133 which axially extend from the bottom 131 to the top edge 134 of the mounting hole 13, and between the positioning grooves 133 are formed plural teeth 135.

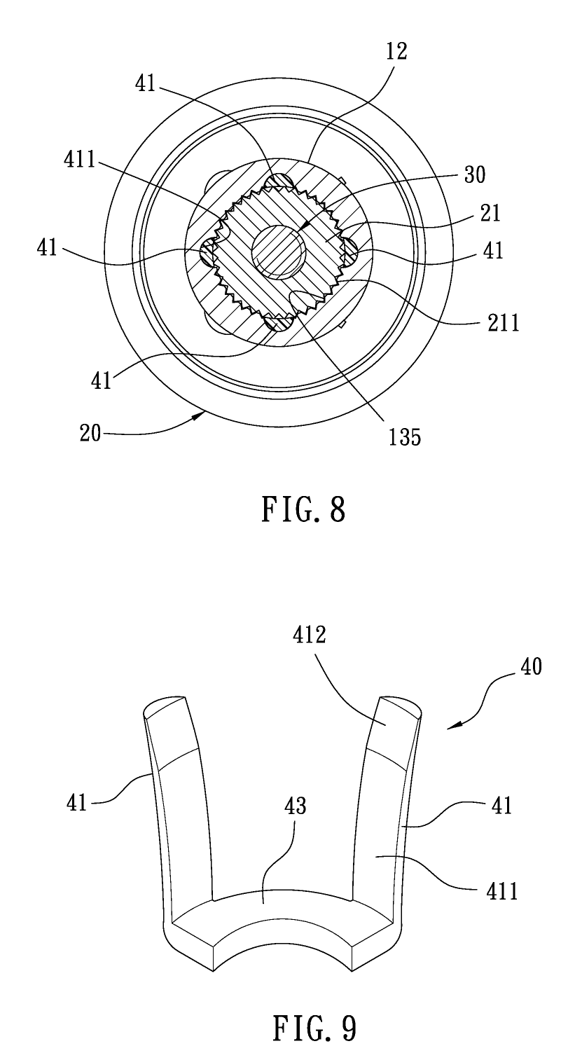

The valve plug 20 is essentially made of metal and disposed in a valve seat (not shown) to control the flow passage of the valve seat. A rod-shaped second connecting portion 21 extends from the top end of the valve plug 20 and is to be inserted in the mounting hole 13 of the lever handle 10 in such a manner that plural teeth 211 formed around the top periphery of the second connecting portion 21 are engaged with the teeth 135 of the mounting hole 13, as shown in FIGS. 7 and 8. The top of the second connecting portion 21 is further formed with a threaded hole 212.

The locking member 30 is a bolt in this embodiment and inserted from the cavity 11 of the lever handle 10 through the aperture 132 in the bottom 131 of the mounting hole 13 and screwed into the threaded hole 212 in the top of the second connecting 21 of the valve plug 20, so that the first and second connecting portions 12, 21 are axially fixed.

The clamping member 40 is made of non-metal material, which can be flexible, wear-resistant plastic material with high friction resistance. The clamping member 40 in this embodiment includes four equiangularly arranged and spaced-apart pushing wedges 41 and a ring-shaped connecting portion 42 formed at the ends of the pushing wedges for connecting the four pushing wedges 41 together, as shown in FIG. 5. The pushing wedges 41 are integrally extended from the outer periphery of the connecting portion 42. Therefore, the ring-shaped connecting portion 42 of the clamping member 40 can be abutted against the bottom 131 of the mounting hole 13 of the lever handle 10, and the central aperture 132 is provided for passage of the locking member 30. Meanwhile, the connecting portion 42 can be clamped between the bottom 131 of the mounting hole 13 of the lever handle 10 and the top of the valve plug 20, as shown in FIG. 7. The pushing wedges 41 are positioned in the corresponding positioning grooves 133 of the mounting hole 13 and each have an arc-shaped concave surface 411 facing the connecting portion 21 of the valve plug 20 and an inclined surface 412 extending upward from the arc-shaped concave surface 411. The arc-shaped concave surfaces 411 are abutted against the teeth 211 of the second connecting portion 21 of the valve plug 20 in an interference fit, as shown in FIG. 8, and the inclined surfaces 412 are used to guide and make the teeth 211 slide to and abut against the corresponding arc-shaped concave surfaces 411.

Referring then to FIGS. 4 and 5, in assembly of the lever handle and the valve plug of the above embodiment, the connecting portion 42 of the clamping member 40 is disposed in the mounting hole 13 of the lever handle 10, and the pushing wedges 41 are aligned with and inserted in the corresponding positioning grooves 133 of the mounting hole 13, such that the pushing wedges 41 can slide along the positioning grooves 133 until the connecting portion 42 is abutted against the bottom 131 of the mounting hole 13, as shown in FIG. 6, and thus the clamping member 40 is positioned in place. After that, the top of the second connecting portion 21 of the valve plug 20 is inserted in the mounting hole 13 of the lever handle 10, and the teeth 211 on the top periphery of the second connecting portion 21 are engaged with the teeth 135 of the mounting hole 13 in a clearance fit, meanwhile, the teeth 211 of the second connecting portion 21 facing the respective pushing wedges 41 of the clamping member 40 will slide along the inclined surface 412 of the respective pushing wedges 41 to the arc-shaped concave surface 411 and will be abutted against the arc-shaped concave surface 411 appropriately in an interference fit until the top of the second connecting portion 21 is abutted against the connecting portion 42 of the clamping member 40, as shown in FIGS. 7 and 8. Then, the locking member 30 is inserted through the aperture 132 of the lever handle 10 and screwed into the threaded hole 212 of the second connecting portion 21. In this way, the lever handle 10, clamping member 40 and the valve plug 20 can be closely assembled together, as shown in FIGS. 3 and 7, and the assembly operation is easy and quick.

When the lever handle 10 and the valve plug 20 of the above embodiment are assembled together, since the arc-shaped concave surface 411 of the respective pushing wedges 41 of the clamping member 40 can be elastically abutted against the teeth 211 around the top periphery of the second connecting portion 21 of the valve plug 20, plus the respective pushing wedges 41 can be positioned in the respective positioning grooves 133 of the mounting hole 13 of the lever handle 10, it ensures that the lever handle 10 and the valve plug 20 can be closely assembled together, and the clearance between the lever handle 10 and the valve plug 20 can be eliminated. As a result, the lever handle 10 won't be loose and unstable when in use, and the accelerated wear and tear caused by the clearance between the teeth 135 and 211 can also be prevented. Hence, besides extending the life of the assembly structure of the lever handle 10 and the valve plug 20, the present invention further permits the lever handle 10 to be rotated and positioned more precisely.

The above embodiment of the clamping member 40 that has four pushing wedges 41 extending from the connecting portion 42 is only for illustration, but not for limitation purpose. Basically, it can also achieve the expected effect as along as the clamping member 40 has at least two approximately symmetrically-arranged pushing wedges 41 and there are two positioning grooves 133.

The above embodiment of the clamping member 40 that the pushing wedges 41 are connected by a ring-shaped connecting portion 42 is for illustration only, not for limitation purpose. It can also be such that there are two pairs of pushing wedges 41, and each two pushing wedges 41 are connected to each other with a semicircular-shaped connecting portion 42, as shown in FIG. 9.

While we have shown and described various embodiments in accordance with the present invention, it is clear to those skilled in the art that further embodiments may be made without departing from the scope of the present invention.

What is claimed is:

1. An assembly structure of a lever handle and a valve plug, comprising:
a lever handle including a metal made first connecting portion, a bottom of the first connecting portion being defined with a mounting hole, and around an inner periphery of the mounting hole being defined at least two spaced-apart axially extending positioning grooves, and between the positioning grooves being formed plural teeth;
a valve plug having a metal made second connecting portion to be inserted in the mounting hole of the lever handle in such a manner that plural teeth formed around one end of the second connecting portion are engaged with the teeth of the mounting hole;
a locking member inserted through the mounting hole and fixed to an end of the valve plug; and
a clamping member made of non-metal material and having at least two pushing wedges and a connecting portion formed at an end of the pushing wedges facing a bottom of the mounting hole, the pushing wedges being positioned in the corresponding positioning grooves of the mounting hole and each having an arc-shaped concave surface for pressing against the teeth of the valve plug, and the connecting portion being clamped between the bottom of the mounting hole of the lever handle and the end of the valve plug.

2. The assembly structure of a lever handle and a valve plug as claimed in claim 1, wherein the pushing wedges are radially restricted in the positioning grooves.

3. The assembly structure of a lever handle and a valve plug as claimed in claim 1, wherein the pushing wedges are axially restricted in the positioning grooves.

4. The assembly structure of a lever handle and a valve plug as claimed in claim 1, wherein the connecting portion of the clamping member is ring-shaped.

5. The assembly structure of a lever handle and a valve plug as claimed in claim 1, wherein the connecting portion of the clamping member is C-shaped.

6. The assembly structure of a lever handle and a valve plug as claimed in claim 1, wherein an end of the respective pushing wedges facing a top end of the mounting hole is formed with an inclined surface through which the teeth of the valve plug are guided to and abutted against the corresponding arc-shaped concave surfaces.

7. The assembly structure of a lever handle and a valve plug as claimed in claim 1, wherein the clamping member is integrally formed by plastic material.
